(19) United States
(12) Patent Application Publication
(10) Pub. No.: US 2008/0046512 A1
(43) Pub. Date: Feb. 21, 2008

(54) METHOD AND SYSTEM FOR ENHANCED ELECTRONIC COMMUNICATIONS

(75) Inventors: Angela Richards Jones, Durham, NC (US); Kalena C. Kelly, Raleigh, NC (US); Regina S. McAuley, Durham, NC (US)

Correspondence Address: CANTOR COLBURN LLP - IBM RSW, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/465,016

(22) Filed: Aug. 16, 2006

(51) Int. Cl. G06F 15/16

(52) U.S. Cl. 709/204; 709/207

(57) ABSTRACT

A method for providing enhanced participation in a chat application is disclosed. The chat application allows an inviter to invite a guest, via a guest chat client, to participate in a conversation between the inviter via an inviter chat client and at least one participant via a participant chat client, the method including making available to the guest, by request of the inviter, a real-time view of the conversation from a perspective of the inviter. The real-time view of the conversation, from the perspective of the inviter, via the inviter chat client, comprises a connection absent the participant chat client. The making available to the guest the real-time view of the conversation from the perspective of the inviter comprises forwarding the conversation from the inviter chat client to the guest chat client.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to electronic communication and particularly to enhanced control of member involvement within an electronic conversation.

2. Description of Background

Instant messaging has become widely used in corporate settings, and is one means to communicate, via electronic conversations, or messages, very quickly. Often, a sender asks a party a question and expects a response right away. Many times, the party has to check with someone else, who may be an expert regarding the subject matter of the question posed by the sender. In the sense of instant messaging, it is time consuming to have the party start another instant messaging, or chat, session with someone else, copy the question from the instant messaging window with the sender to another instant messaging window with someone else, and then copy and paste someone else's response to the window of the original conversation with the sender. This becomes further complicated and time consuming when the response elicits yet further questions from the sender about which the party has to check with someone else.

One solution is to have someone else join the chat session and form an instant messaging meeting with all three parties. Another solution allows a user to discreetly enter an instant messaging meeting and select which (if any) on-line participants are allowed to see them as “on-line”. At any time, the user can show themselves as available to the other participants and take part in the session.

However, the party may not want the sender to see from whom the answers are provided. This may be typical in a situation where the party is a first-line manager, the sender is an executive, and someone else is a technical expert. The executive is asking the manager questions about the product, and the manager needs to get the details from the technical expert, but feels it would be inappropriate to bring the technical person into the chat session. More importantly, inviting someone to a meeting grants everyone equal privileges to “speak”. The manager may want to screen the information given to the executive. Accordingly, there is a need in the art for an electronic communications arrangement that overcomes these drawbacks.

### SUMMARY OF THE INVENTION

The shortcomings of the prior art are overcome and additional advantages are provided through the provision of a system and method to allow one instant messaging member to invite and control the participation of another member within the instant messaging chat session, absent the knowledge of any other instant messaging members.

An embodiment of the invention includes a method for providing enhanced participation in a chat application. The chat application allows an inviter to invite a guest, via a guest chat client, to participate in a conversation between the inviter via an inviter chat client and at least one participant via a participant chat client, the method including making available to the guest, by request of the inviter, a real-time view of the conversation from a perspective of the inviter. The real-time view of the conversation, from the perspective of the inviter, via the inviter chat client, comprises a connection absent the participant chat client. The making available to the guest the real-time view of the conversation from the perspective of the inviter comprises forwarding the conversation from the inviter chat client to the guest chat client.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which allows one instant messaging member to invite and control the participation of another member within the instant messaging chat session, absent the knowledge of any other instant messaging members, thereby enhancing efficiency of communication.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a pictorial representation of an enhanced electronic communication system in accordance with an embodiment of the invention.

FIG. 2 illustrates one example of a pictorial representation of an enhanced electronic communication system with focus upon display screen views in accordance with an embodiment of the invention.

FIG. 3 illustrates one example of a flowchart of a method to enhance participation in an electronic conversation in accordance with an embodiment of the invention.

The detailed description explains the preferred embodiments of the invention, together with advantages and features, by way of example with reference to the drawings.

### DETAILED DESCRIPTION OF THE INVENTION

In an embodiment, the invention will provide a method to allow a member (also herein referred to as an inviter) of an existing instant messaging conversation between the inviter and at least one participant (also herein referred to as the participant) to include a guest outside of the conversation to view the session in real-time by sharing the inviter's view and identity with the guest. In an embodiment, the settings pertaining to the view shared with the guest are controlled by the inviter, and not by the guest. Also, the guest will not actually be present in the “chatroom” of the conversation, and therefore will not have the option to appear as a member, or to send unmonitored messages to the participant on the other end.

In an embodiment, an enhanced messaging system will allow the inviter involved in an existing conversation to permit the third party guest to electronically “glance over the shoulder” of the inviter to see a live chat session and to also be able to type messages on the inviter's behalf. In this scenario, the participant and the inviter are engaged in a chat session. The participant asks the inviter a question, and the inviter provides a live view of the chat session from the inviter's perspective to the guest so that the guest can answer this question on the behalf of the inviter.

In an embodiment, there are at least two settings available to the “over-the-shoulder” view. One setting is read-only, to provide the guest with the capability only to observe the conversation between the participant and the inviter for informational purposes. The other setting is delegate, whereby the guest is capable to read and write message replies. However, in the delegate setting, the guest has no authority to actually send any messages.

In an embodiment, all messages provided by the guest will appear in a view from a perspective of the inviter. This allows the inviter to review the message provided by the guest and determine if they want to send this information forward to the participant. In an embodiment, the inviter will review, and, if necessary, edit the message provided by the guest, and subsequently send the reviewed message forward to the participant.

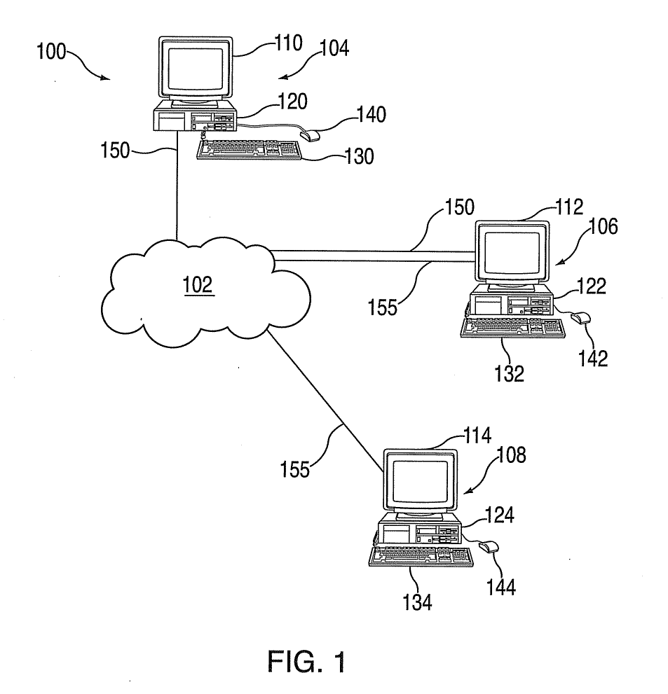

With reference now to the figures, and in particular, with reference to FIG. 1, a pictorial representation of an enhanced electronic communication system 100, in which the present invention may be implemented, is depicted.

Enhanced communication system 100 contains a network 102, which is the medium used to provide communication links between various devices and computers connected together within the warning system 100. The network 102 may include permanent connections, such as wire or fiber optic cables, temporary connections made through telephone connections, or wireless connections, for example.

In the depicted example, computers (also herein referred to as chat clients) 104-108 are each connected to the network 102, and are configured to provide electronic communication via the network 102. The chat clients 104-108 may be, for example, personal computers or network computers. The enhanced communication system 100 may include additional computers, such as servers, and clients, for example, and other devices not shown. In an example, the enhanced communication system 100 includes the Internet, with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational, and other computer systems, that route data and messages. Of course, the enhanced communication system 100 also may be implemented as a number of different types of networks 102, such as an Intranet or a local area network, for example.

Each chat client 104-108 within the enhanced communication system 100 may have a program storage device 120-124 to store system, data, and application files. Output devices, such as CRT display screens 110-114, are configured to display a chat window, for example, and input devices, such as keyboards 130-134, and mice 140-144, for example, are configured to enter text to prepare and provide electronic conversations comprising electronic messages, for example. In an embodiment, each chat client 104-108 is configured to communicate with the others via the network 102, in a manner known in the art as instant messaging.

While an embodiment of the invention has been described to use keyboards 130-134 and mice 140-144 as input devices, and CRT display screens 110-114 as output devices to conduct electronic communication, it will be appreciated that the scope of the invention is not so limited, and that the invention also applies to an enhanced communication system 100 that may utilize alternate input and output devices, such as writing tablets, voice recognition, and audio speakers, for example.

FIG. 1 is intended as an example, and not as an architectural limitation for the processes of the present invention.

In an embodiment, the enhanced communication system 100 includes at least one participant chat client 104 configured to make available communication between at least one participant and an inviter via a first network connection 150 to an inviter chat client 106. In an embodiment, the inviter chat client 106 is configured to establish a second network connection 155 with a guest chat client 108 to allow a guest to observe, in real-time, a conversation between the inviter and the at least one participant.

In an embodiment, the inviter chat client 106 is configured to establish the second network connection 155 exclusive of the first network connection 150 and forward the conversation between the participant and the inviter via the second network connection 155 to the guest chat client 108, thereby causing the participant to be unaware of the forwarding of the conversation.

While an embodiment of the invention has been described and depicted illustrating a discreet first and second network connection construction between each of the at least one participant chat client and the inviter chat client, and, the inviter chat client and the guest chat client, it will be appreciated that the scope of the invention is not so limited, and that the invention will also apply to enhanced communication systems having alternate connectivity constructions that may consolidate the first and second network connections, such as a ring design, for example.

While an embodiment of the invention has been described with three chat clients linked together via a common network for the purposes of electronic communication, it will be appreciated that the scope of the invention is not so limited, and that the invention will also apply to other arrangements of computers connected together, such as one network of computers in signal communication with another network of computers that may be located as far apart as to be on different continents, for example.

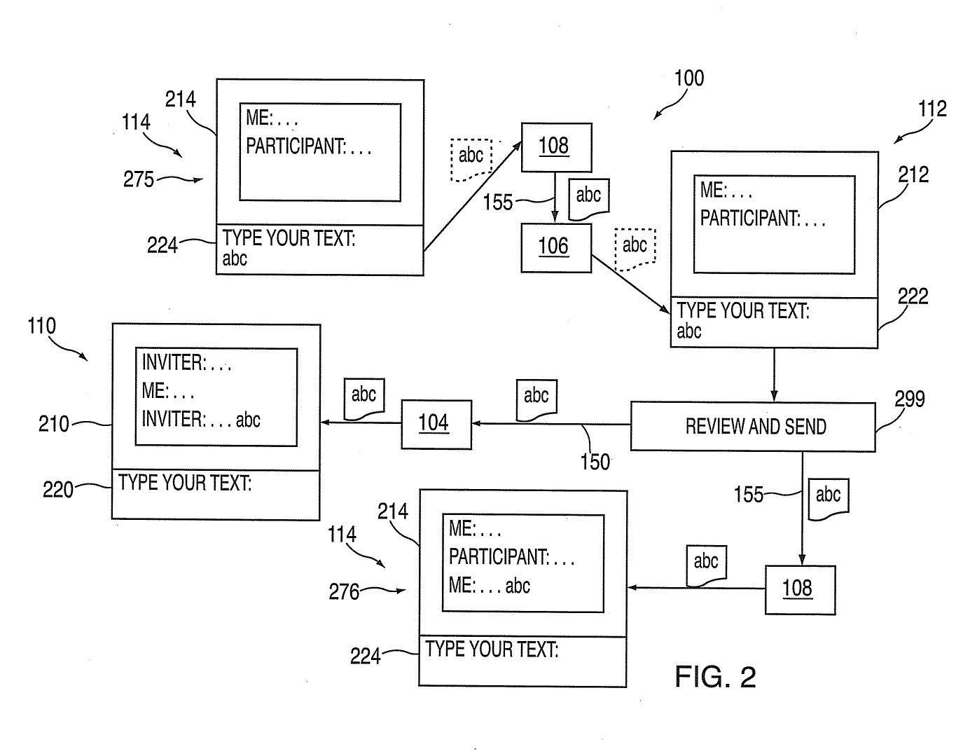

Referring now to FIG. 2, an alternate view of an embodiment of the enhanced communication system 100 is depicted, with focus upon the views of the CRT screens 110-114.

The CRT 112 of the inviter chat client 106 is configured to display a conversation from a perspective of the inviter via a conversation box 212 and a text box 222. In an embodiment the conversation box 212 is configured to display the contents of the conversation between the involved parties. In an embodiment, the text box 222 is configured to allow entry, via typing, of any communication of the inviter.

While an embodiment of the invention has been depicted having a user interface comprising a large conversation box and a smaller text box located toward the bottom of the view, it will be appreciated that the scope of the invention is not so limited, and that the invention will also apply to enhanced communication systems employing user interfaces that may have alternate arrangements, such as a large text box located to the side of an equally sized conversation box, or a small text box located above a large conversation box, for example.

In an embodiment, it will be appreciated that one means to follow the conversation is to precede any conversation content with the identity of the source party. For example, as depicted by the CRT 112, it will be appreciated that the conversation between the inviter and the participant is displayed from the perspective of the inviter, who is identified as “me” in the conversation box 212. In similar fashion, the CRT 110 of the participant chat client 104 comprises a conversation box 210 and a text box 220. It will also be appreciated that in the CRT 110 of the participant chat client 104, the conversation between the participant and the inviter is displayed from the perspective of the participant, who is identified as “me” in the conversation box 210. In an embodiment, the CRT 114 of the guest chat client 108 is configured to display the conversation from the perspective of the inviter.

While an embodiment has been described illustrating an exemplary conversation between two parties, the inviter and the participant, it will be appreciated that the scope of the invention is not so limited, and the invention will also apply to other electronic conversations, such as electronic conversations that may have additional parties, including multiple participants, and more than one inviter, which may each invite, unknown to any of the other parties of the conversation, one or more guests, for example.

In an embodiment, the inviter chat client 106 is configured to allow the inviter to select at least one of a read-only mode of operation, to allow the guest to only read the conversation between the inviter and the at least one participant, and a delegate mode of operation, to additionally allow the guest to provide a set of replies, the set of replies visible only within the text box 222, 224 of the view 112, 114 available to the inviter and the guest. In an embodiment, the inviter chat client 106 is configured to allow the inviter to read, edit, and send the set of replies to the at least one participant, thereby causing the at least one participant to perceive that the set of replies originate from the inviter. As used herein, reference numerals 110, 112, and 114 shall also be used to refer to the views displayed upon the CRT screens 110, 112, and 114.

With reference to FIG. 2, an exemplary conversation between the inviter and the participant, with the delegate mode of operation selected by the inviter, is depicted. Reference numeral 275 depicts the screen 114 of the guest, configured to display the conversation from the perspective of the inviter. As the guest enters, by typing for example, text (shown by the letters “abc” in FIG. 2), it is displayed in the text box 224. Subsequent to directing the guest chat client 108 to provide the text, by executing a send command, for example, the guest chat client 108 provides the text via the second network connection 155 to the inviter chat client 106. In response to the text provided by the guest arriving at the inviter chat client 106, it is displayed in the text box 222 of the screen 112 of the inviter chat client 106. Subsequent to the display of the text provided by the guest chat client 106, the inviter will review the text, determine its acceptability, edit it if necessary, and send it (as depicted by action box 299) from the inviter chat client 106 to the participant chat client 104 via the first network connection 150. The text will then be shown in the conversation box 210 of the display 110 of the participant chat client 104. It will be appreciated that at the same time that the inviter chat client 106 transmits the text to the participant chat client 104 via the first network connection 150, it will also send to the guest chat client 108 an updated view (shown by reference numeral 276) of the conversation, from the perspective of the inviter, for display upon the CRT 114 of the guest chat client 108. It will be appreciated that, from the perspective (as depicted by CRT 110) of the participant, the only parties of the conversation are the participant and the inviter, and the participant is therefore unaware of the presence and involvement of the guest within the conversation.

In an embodiment, the involvement of the guest in the conversation will not be indicated in any of the conversation boxes 210, 212, 214, and will be visible only to the inviter from which the guest is dependent. In an embodiment, the involvement of the guest will be visible only to the inviter from which the guest is dependent via the text box 222. In an embodiment, the inviter chat client and the guest chat client are configured to share an identity of the inviter chat client within the conversation.

While an embodiment of the invention has been described and depicted having the parties of the conversation named as “participant” and “inviter”, it will be appreciated that the scope of the invention is not so limited, and that the invention will also apply enhanced communication systems that may allow any variety of party names, such as user-selected aliases and corporate user identifications, for example.

While an embodiment of the invention has been depicted and described showing the inviter choosing to send the text provided by the guest forward to the participant without changing, or editing, it will be appreciated that the scope of the invention is not so limited, and that the invention will also apply to text provided by the guest that the inviter chooses not to send, or to edit, prior to sending forward to the participant. If the inviter does not approve of a message provided by the guest, the inviter can modify it before sending it on to the participant, because the text provided by the guest is provided into the text box 222 of the inviter. In an embodiment, instead of forwarding “abc”, the inviter can decide to edit it to read “abd”. In that case, the text displayed on the conversation box 210 of the participant, and the conversation box 214 of updated view 276 of the guest will display “abd” rather than “abc”, thereby reflecting the edit by the inviter of the text provided by the guest.

In an embodiment, the inviter chat client 106 is configured to make available to the guest, via the guest chat client 108, a history of the conversation that occurred prior to guest being invited to participate in the conversation via establishing the second network connection 155. In an embodiment, this will allow the guest to become more informed regarding the background context preceding the joining of the guest in the real-time view 112 of the conversation. However, there may be content within the conversation, prior to the inviter inviting the guest, of which the inviter would prefer the guest not be aware. In another embodiment, the inviter chat client 106 is configured to allow the inviter to designate a portion of the history of the conversation that occurred prior to establishing the second network connection 155 to make available to the guest.

It may occur that while the guest is attempting to provide the set of replies in the text box 224, the inviter is also preparing the reply in the text box 222. Accordingly, it will be appreciated that a control is needed to manage the sending of the set of replies entered in the text box 224 corresponding to the guest chat client 108 to the text box 222 corresponding to the inviter chat client 106. In an embodiment, the inviter chat client 106 is configured to notify the inviter in response to an attempt by the guest to provide the set of replies while the inviter is preparing a reply within the text box 222. In an embodiment, following notification that the guest is attempting to provide the set of replies, the inviter chat client 106 is configured to allow the inviter to select a reply reaction mode following the attempt by the guest to provide the set of replies. In an embodiment, the reply reaction mode is configured to include at least one of a first mode configured to allow the set of replies attempted to be provided by the guest to override the reply being prepared by the inviter, a second mode configured to save the set of replies attempted to be provided by the guest for entering into the text box 222 following completion of the reply being prepared by the inviter, and a third mode configured to save the reply being prepared by the inviter for entering into the text box 222 subsequent to entry of the set of replies attempted to be provided by the guest.

In view of the foregoing, the enhanced communication system 100 performs the method of providing enhanced participation in a chat application, allowing an inviter to invite a guest to participate in a conversation between the inviter and at least one participant.

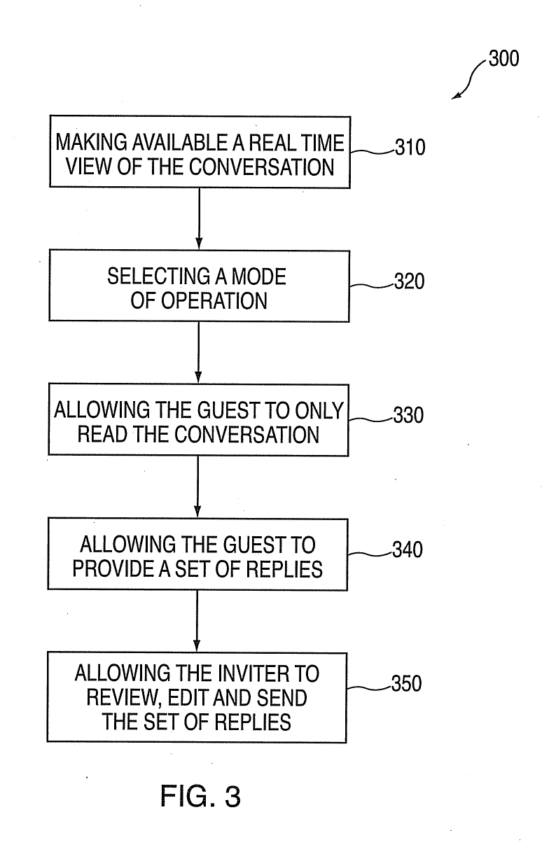

Referring now to FIG. 3, a flow chart 300 of an embodiment of a method to provide the enhanced participation in the chat application is depicted.

The method begins with making available 310 to the guest, by request of the inviter, the real-time view of the conversation from the perspective of the inviter and selecting 320, by the inviter, the mode of operation of the view to make available to the guest. In an embodiment, the making available 310 to the guest, via the guest chat client 108, the real-time view 112 of the conversation from the perspective of the inviter, via the inviter chat client 106, comprises the first network connection 150 absent the participant chat client 104. In an embodiment, the making available 310 to the guest the real-time view 112 of the conversation from the perspective of the inviter comprises forwarding the conversation from the inviter chat client 106 to the guest chat client 108 via the second network connection 155. In an embodiment, the method further includes sharing, within the conversation, the identity of the inviter chat 106 client with the guest chat client 108.

In response to the inviter selecting 320 the read-only mode of operation, allowing 330 the guest to only read the conversation. In response to the inviter selecting 320 the delegate mode of operation, allowing 340 the guest to read the conversation and provide the set of replies to the conversation, the set of replies being allowed to appear only in the text box 222, 224 of the view 112, 114 from the perspective of the inviter.

The method proceeds by allowing 350 the inviter to review, edit and send the set of replies provided by the guest to the at least one participant. In an embodiment, the sending the set of replies to the at least one participant comprises the view 110 from the perspective of the participant, the view 110 comprising only the set of replies that have been sent by the inviter, and absent the set of replies from the guest that have not been forwarded by the inviter.

In an embodiment, the method further includes making available to the guest the history of the conversation that occurred prior to the making available to the guest the real-time view 112 of the conversation from the perspective of the inviter. An embodiment also includes selecting, by the inviter, a portion of the history of the conversation that occurred prior to making available to the guest the real-time view 112 of the conversation from the perspective of the inviter.

Another embodiment includes preparing the reply, by the inviter, within the text box 222 of the view 112 from the perspective of the inviter, attempting, by the guest, to provide the set of replies in the text box 224 of the view 114 from the perspective of the guest, and in response to the guest attempting to provide the set of replies while the inviter is preparing the reply within the text box 222 of the view 112 from the perspective of the inviter, notifying the inviter of the attempt by the guest to provide the set of replies.

In an embodiment, following the notifying the inviter of the attempt by the guest to provide the set of replies, selecting, by the inviter, the reply reaction mode allowed to include at least one of allowing the set of replies attempted to be provided by the guest to override the reply being prepared by the inviter, saving the set of replies attempted to be provided by the guest for entering into the text box 222 subsequent to completion of the reply being prepared by the inviter, and saving, for subsequent entry into the text box 222, the reply being prepared by the inviter, and entering into the text box 222 the set of replies attempted to be provided by the guest.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for providing enhanced participation in a chat application, the chat application allowing an inviter to invite a guest, via a guest chat client, to participate in a conversation between the inviter via an inviter chat client and at least one participant via a participant chat client, the method comprising:
making available to the guest, by request of the inviter, a real-time view of the conversation from a perspective of the inviter;
selecting, by the inviter, a mode of operation of the view to make available to the guest;
in response to the inviter selecting a read-only mode of operation, allowing the guest to only read the conversation; and
in response to the inviter selecting a delegate mode of operation, allowing the guest to read the conversation and provide a set of replies to the conversation, the set of replies being allowed to appear only in a text box of the view from the perspective of the inviter;
allowing the inviter to review, edit and send the set of replies provided by the guest to the at least one participant;
wherein the making available to the guest, via the guest chat client, the real-time view of the conversation from the perspective of the inviter, via the inviter chat client, comprises a connection absent the participant chat client;
wherein the making available to the guest the real-time view of the conversation from the perspective of the inviter comprises forwarding the conversation from the inviter chat client to the guest chat client; and
wherein the sending the set of replies to the at least one participant comprises a view from a perspective of the participant absent the set of replies from the guest that have not been forwarded by the inviter.

2. The method of claim 1, further comprising:
making available to the guest a history of the conversation that occurred prior to the making available to the guest the real-time view of the conversation from the perspective of the inviter.

3. The method of claim 2, wherein the making available to the guest the history of the conversation comprises:
selecting, by the inviter, a portion of the history of the conversation that occurred prior to making available to the guest the real-time view of the conversation from the perspective of the inviter.

4. The method of claim 1, further comprising:
preparing a reply, by the inviter, within the text box of the view from the perspective of the inviter; and
attempting, by the guest, to provide the set of replies;
in response to the guest attempting to provide the set of replies while the inviter is preparing the reply, notifying the inviter of the attempt by the guest to provide the set of replies.

5. The method of claim 4, further comprising:
selecting, by the inviter, a reply reaction mode following the notifying the inviter of the attempt by the guest to provide the set of replies, the reply reaction mode allowed to include at least one of:
allowing the set of replies attempted to be provided by the guest to override the reply being prepared by the inviter;
saving the set of replies attempted to be provided by the guest for entering into the text box subsequent to completion of the reply being prepared by the inviter; and
saving, for subsequent entry into the text box, the reply being prepared by the inviter, and entering into the textbox the set of replies attempted to be provided by the guest.

6. The method of claim 1, further comprising:
sharing, within the conversation, an identity of the inviter chat client with the guest chat client.

7. A program storage device readable by a machine, the device embodying a program or instructions executable by the machine to perform the method of claim 1.

8. An enhanced messaging system comprising:
at least one participant chat client configured to make available communication between at least one participant and an inviter via a first network connection to an inviter chat client;
wherein the inviter chat client is configured to establish a second network connection with a guest chat client to allow a guest to observe, in real-time, a conversation between the inviter and the at least one participant;
wherein the inviter chat client is configured to establish the second network connection exclusive of the first network connection and forward the conversation via the second network connection to the guest chat client, thereby causing the at least one participant to be unaware of the forwarding of the conversation;
wherein the inviter chat client is configured to allow the inviter to select at least one of a read-only mode of operation, to allow the guest to only read the conversation between the inviter and the at least one participant, and a delegate mode of operation, to additionally allow the guest to provide a set of replies, the set of replies visible only within a text box of a view available to the inviter and the guest; and
wherein the inviter chat client is configured to allow the inviter to read, edit, and send the set of replies to the at least one participant, thereby causing the at least one participant to perceive that the set of replies originate from the inviter.

9. The system of claim 8, wherein:
the inviter chat client is configured to make available to the guest a history of the conversation that occurred prior to establishing the second network connection.

10. The system of claim 9, wherein:
the inviter chat client is configured to allow the inviter to designate a portion of the history of the conversation that occurred prior to establishing the second network connection to make available to the guest.

11. The system of claim 8, wherein:
the inviter chat client is configured to notify the inviter in response to an attempt by the guest to provide the set of replies while the inviter is preparing a reply within the text box.

12. The system of claim 11, wherein:
the inviter chat client is configured to allow the inviter to select a reply reaction mode following the attempt to provide the set of replies, the reply reaction mode configured to include at least one of:
a first mode configured to allow the set of replies being attempted by the guest to override the reply being prepared by the inviter;
a second mode configured to save the set of replies being attempted by the guest for entering into the text box following completion of the reply being prepared by the inviter; and
a third mode configured to save the reply being prepared by the inviter for entering into the text box subsequent to entry of the set of replies being attempted by the guest.

13. The system of claim 8, wherein:
the inviter chat client and the guest chat client are configured to share an identity of the inviter chat client within the conversation.
